(19) United States
(12) Patent Application Publication
(10) Pub. No.: US 2007/0130191 A1
(43) Pub. Date: Jun. 7, 2007

(54) Method and system for analyzing effectiveness of compliance function

(75) Inventor: Michael A. Dawson, Washington, DC (US)

Correspondence Address: Fortkort & Houston;Suite 500, 9442 N. Capital of Texas Highway, Arboretum Plaza One, Austin, TX, 78759, US

(73) Assignee: Promontory Compliance Solutions, LLC, Washington, DC (US)

(21) Appl. No.: 11/282,291

(22) Filed: Nov. 18, 2005

(51) Int. Cl. G06F 7/00

(52) U.S. Cl. 707/102

(57) ABSTRACT

A method quantifies compliance risk management effectiveness at a point in time and over time. A computer-implemented method for doing so creates a graphical display of compliance exceptions identified within the organization over time and displays a plot or curve for each source that identified the compliance exceptions. The graphical display may include: an audit function plot; a business line plot; a compliance function plot; and/or a regulator plot. An apparatus for monitoring and analyzing compliance risk in includes a database, a processor and a graphical user interface. The database stores data regarding identified compliance exceptions. The processor weights each compliance exception and categorizes each source. The graphical user interface separately plots a resulting value of weighted compliance exceptions based on source.

### FIELD OF THE INVENTION

The present invention relates generally to methods and apparatuses for managing risk associated with compliance with various laws, regulations, standards, and codes of conduct (“compliance obligations”), and more particularly to a method and apparatuses for managing risk associated with compliance obligations in the financial services industry.

### BACKGROUND OF THE INVENTION

In recent years, financial institutions and other organizations have experienced heightened regulatory scrutiny, negative media attention, reputational damage, legal liability, and other sanctions for violations of compliance obligations and other breakdowns in controls. This, in turn, has given rise to an increased attention by regulators and corporations on the role of compliance, particularly in large, complex organizations. In addition, regulators and Boards of Directors have required corporations to increase the amount of resources they devote to compliance risk management.

Notwithstanding this increase in resources, compliance risk management is still a relatively immature discipline. Some major financial institutions, for example, have only recently created a global compliance function charged with managing compliance risk across the entire institution. As another example, some financial institutions have only recently created a “compliance committee” of the Board of Directors similar to an “audit committee,” but dedicated to overseeing compliance risk management. As still another example, the Basel Committee on Banking Supervision only recently published a final version of a high-level paper on “Compliance and the Compliance Function in Banks,” that seeks to explain the roles of the Board of Directors, Senior Management, and the compliance function in managing compliance risk within a banking organization.

As the focus by Regulators and Boards of Directors on compliance risk management increases and as the amount of resources devoted to compliance risk management increase, it has become increasingly important to measure the effectiveness of an organization's compliance risk management. This has proven difficult. One of the difficulties in measuring effectiveness arises from the fact that compliance violations are not always public. Therefore, while an organization may have data about compliance violations experienced within its own organization, organizations typically lack comparative data that enables them to compare their record of compliance violations with the records of other, similar organizations. Current methods of managing compliance risk tend to overcome this difficulty by focusing on inputs. In a common method, organizations “benchmark” the amount of money they are spending, and the number of people they are hiring, against the amounts spent and numbers hired and trained by other organizations of similar nature and size. This, however, does not measure whether the inputs are producing desired results.

Another method of overcoming the difficulty tends to focus on negative outcomes within an organization. Where an organization experiences a compliance violation that leads to an adverse regulatory action, the organization often concludes that its compliance risk management was ineffective and takes steps to change it. This approach has an important limitation. It only allows an organization to conclude retrospectively that its compliance risk management was ineffective. It does not allow the organization to analyze its compliance risk management and assess whether it is effective or ineffective on a current prospective basis. This further limits the organization's ability to make adjustments to improve the effectiveness over time.

What is missing from current approaches to compliance risk management is a method for analyzing effectiveness based on outputs over time that does not require comparisons to loss experiences of other organizations and that facilitates proactive management of compliance risks, rather than waiting until after an adverse regulatory action to form judgments about the effectiveness of compliance risk management.

The present invention is therefore directed to the problem of developing a method and apparatus for analyzing the effectiveness of compliance risk management in an organization.

### SUMMARY OF THE INVENTION

The present invention solves the problems associated with measuring the effectiveness of an organization's compliance risk management function, as well as other problems, by providing, inter alia, a method for quantifying the function's effectiveness both at any one point in time but also over time as organizations alter their approach to compliance risk management by, for example, increasing the amount of resources they devote to compliance risk management.

The present invention also provides a method for explaining a fundamental teaching of enterprise-wide risk management known as “the three lines of defense.” This concept holds that line of business management is the first line of defense, the compliance function is the second line of defense, and the audit function, whether this function is performed internally or outsourced, is the third line of defense. If compliance risk management is functioning effectively, line of business management will identify the most exceptions, followed by the compliance function, followed by the audit function. Each of these three lines of defense should identify more exceptions than regulators. Even if these exceptions are subsequently disclosed to the regulators, as is often the practice, the fact that the organization self-identified and corrected the exceptions will minimize fines, penalties, sanctions, and other disadvantageous outcomes associated with non-compliance.

According to one aspect of the present invention, a computer-implemented method for analyzing compliance risk in an organization includes creating a graphical display of compliance exceptions identified within the organization over time and displaying on the graphical display a plot or a curve for each source that identified the compliance exceptions over time. According to this computer implemented method, the graphical display may include one or more of the following plots or curves: a line of business management plot or curve that depicts a number of compliance exceptions over time identified by a business line; a compliance function plot or curve that depicts a number of compliance exceptions over time identified by a compliance function; an audit function plot or curve that depicts a number of compliance exceptions over time identified by an audit function; and/or a regulator plot or curve that depicts a number of compliance exceptions over time identified by regulators that perform regulatory oversight over the organization.

According to another aspect of the present invention, a computer-implemented method for analyzing compliance risk in an organization includes: storing data regarding each compliance exception of the organization, wherein the data includes at least a time when the compliance exception was identified, and a source that identified the compliance exception; assigning each compliance exception of the organization to one of two or more categories of sources based on an actual source that identified each compliance exception; and creating a graph of plots or curves of a number of compliance exceptions related to the organization identified within a given time period for several periods, one curve for each category of sources. According to this aspect of the present invention, a weight may be assigned to each compliance exception, wherein the weight quantifies a relative significance of each compliance exception. In this alternative embodiment, the step of creating then includes creating a graph of plots or curves of weighted compliance exceptions related to the organization identified within a given time period for several time periods, one plot or curve for each category of sources.

According to yet another aspect of the present invention, an apparatus for monitoring and analyzing compliance risk in an organization includes at least a database, a processor and a graphical user interface. The database stores a number of compliance exceptions identified over time in relation to a source that identified each of the compliance exceptions. The processor scores each compliance exception with a significance value, which significance value quantifies a relative weight of each compliance exception. The processor also categorizes each source that identified each of the compliance exceptions within at least two categories of sources. The graphical user interface separately plots a resulting value of scored compliance exceptions over time identified by the at least two categories of sources. According to this aspect of the present invention, the processor may also determine the significance value by totaling a quantity of losses experienced as a result of a given number of identified compliance exceptions. Alternatively, the processor may determine the significance value by multiplying a given number of identified exceptions by a quantity of losses experienced as a result of the given number of identified exceptions. Still, the processor may determine the significance value by assigning to each compliance exception a number of points based on its relative significance to other compliance exceptions, and by assigning a first number of points to a major exception, a second number of points to a medium exception and a third number of points to a minor exception.

Still other aspects of the present invention will be apparent to those of skill in this art based on the following detailed description and in light of the following drawings.

### BRIEF DESCRIPTION OF THE DRAWINGS

FIG. 1 depicts an exemplary embodiment of a graphical display of a plot of a number of compliance exceptions identified within a given time period for several time periods according to a first aspect of the present invention.

FIG. 2 depicts an exemplary embodiment of a computer-implemented method for analyzing compliance risk in an organization according to another aspect of the present invention.

FIG. 3 depicts another exemplary embodiment of a computer-implemented method for analyzing compliance risk in an organization according to still another aspect of the present invention.

FIG. 4 depicts still another exemplary embodiment of a computer-implemented method for analyzing compliance risk in an organization according to yet another aspect of the present invention.

FIG. 5 depicts an exemplary embodiment of an apparatus for monitoring and analyzing compliance risk in an organization according to yet another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

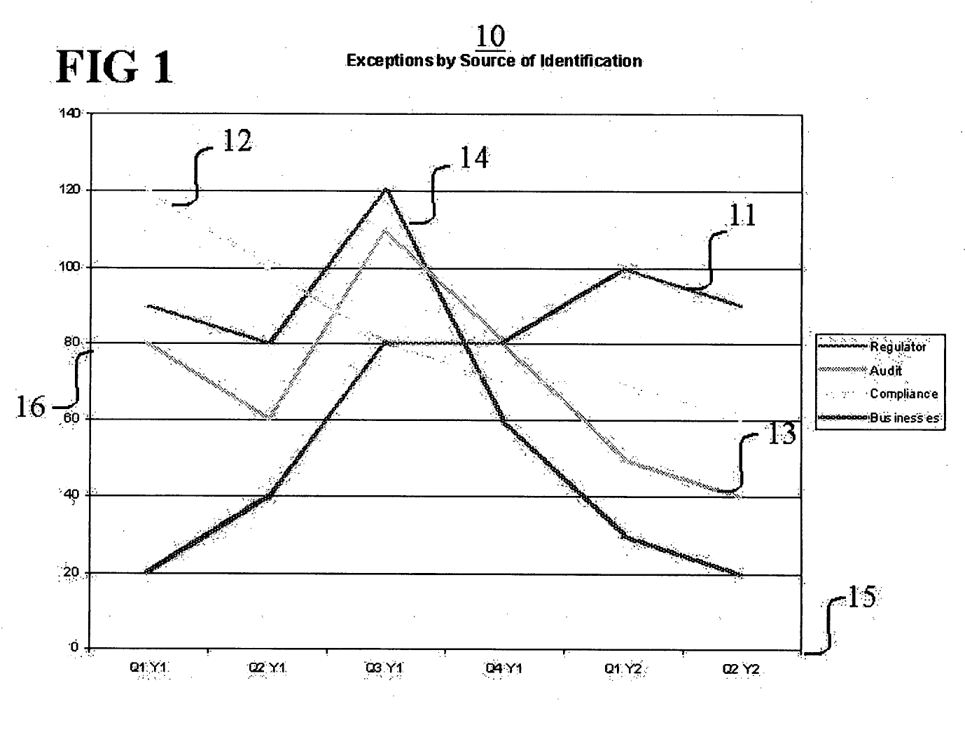

Turning to FIG. 1, shown therein is a graphical implementation 10 resulting from an exemplary embodiment of a method for analyzing compliance risk in an organization according to various aspects of the present invention. Graphical display 10 depicts the number of compliance exceptions identified within a particular time period 16 versus time 15, in this case four particular quarters (Q1-Q4). Other time periods could be employed as well, depending on the exact nature of the organization and a length of its compliance risk management. The exemplary embodiment of the method of the present invention tracks the source of identification of exceptions over time by various categories of sources. In this exemplary embodiment 10, the categories of sources include: (1) a line of business 11; (2) a compliance function 12; (3) an audit function 13; and (4) external regulators 14.

The conclusions one can draw from this particular resulting plot are considerable. For example, the left hand side of the graph depicts ineffective compliance risk management in an organization. In this example, even though the compliance function is finding more exceptions than other organizational functions, auditors and regulators are finding more exceptions than the line of business. Thus, this particular organization's approach to compliance risk management is out-of-balance—the organization has not ordered the lines of defense properly and has exposed the organization to risks that compliance exceptions will lead to fines or other penalties, negative publicity, and/or reputational damage.

However, the right hand side of the graph depicts effective compliance risk management in the organization. Here, the line of business identifies the most exceptions. The compliance function identifies the second most and the audit function the third most. Regulators identify the least number of exceptions. This reflects a proper ordering of the three lines of defense and a minimization of the possibility that the organization will experience a compliance failure that leads to fines or other penalties, negative publicity, and/or reputational damage.

Thus, this particular organization has evolved from ineffective compliance risk management to effective compliance risk management over the time period shown in the graphical display 10.

It should be noted that the curves or plots described herein need not be based on continuously derived data. Rather, the number of exceptions identified in a particular period may be based on a sample done at a particular point in time covering a range of time. In that case, the sample will result in a data point associated with the number of exceptions identified and the time period concerned. Also, not every function will produce data for every time period. For example, line of business functions may identify exceptions on a quarterly basis, whereas audit functions may identify exceptions on an annual basis or even less frequently. In these cases, the graph can normalize the exceptions found by each function by either taking the average of the number of exceptions found each period or by aggregating exceptions found in shorter time periods into the longest period, although this latter method is less desirable. However, the organization may choose to present the data without normalizing it. If, for example, the audit function conducts audits infrequently, but finds a large number of exceptions when it does audit, one way to improve the effectiveness of compliance risk management would be to increase the frequency of audits so that exceptions are identified in a more timely way. Presenting the data in a non-normalized format will highlight the need for more frequent audits.

Moreover, it should be noted that the term organization is not limited to an actual structural organization, but may vary depending on the needs of the analyst. For example, some corporations may have subsidiary corporations that must be considered when managing risk of the parent corporation. In addition, external companies and consultants may provide outsourced functions that must be considered when managing the risk of the business of the corporation. Finally, the resulting entity being analyzed may not have any real corporate structure but may exist across multiple corporate structures and entities. Therefore, the term organization refers simply to any entity to which one desires to manage compliance risk or quantity the effectiveness of its risk compliance management.

According to a further aspect of the present invention, tracking both the number of identified compliance exceptions and the significance of these identified compliance exceptions, rather than just the number of identified compliance exceptions, can enhance the above method of the present invention. In this manifestation, the number and significance of exceptions are tracked on one axis. This can be accomplished by several different techniques.

Firstly, for example, the significance of the identified compliance exceptions can be determined by adding up the quantity of losses experienced as a result of the total number of compliance exceptions identified within each time period.

Secondly, for example, the significance of the identified compliance exceptions can be determined multiplying the numbers of exceptions identified by the quantity of losses experienced as a result of the exceptions.

Thirdly, for example, the significance of the identified compliance exceptions can be determined by assigning to each exception a number of points (e.g., ten for major exceptions, five for medium exceptions, and one for minor exceptions) and tracking the total points “scored” by each function over time.

The above methods can be further enhanced by color coding the time-series to differentiate them from each other, so that the line of business time series is shaded one color, the compliance function time-series is shaded another color, the audit function time-series is shaded still another color and the regulators time-series is shaded yet another color. For example, the line of business time-series might be colored green, the compliance time-series might be colored shaded yellow, the audit time-series might be colored orange, and the regulator time-series might be colored red. These exemplary colors are colors that risk management professionals often associate with varying degrees of positive to negative states of risk management. Effective compliance risk management will raise the green time-series and lower the red time-series, as well as the colors in between these extremes.

While FIG. 1 depicts plots of lines, other plots may be employed to the same effect. For example, bar charts could be employed showing a bar graph for each period by source. Also, pie charts could be used showing the relative percentages of total compliance exceptions identified by source. Additionally, datagrams of the points can be used, with the points connected by lines or not. In general, the graphical displays of the present invention are not limited to those in FIG. 1 or those mentioned here, but can consist of any plots showing the relationship between a number of compliance exceptions identified by source and some temporal relationship.

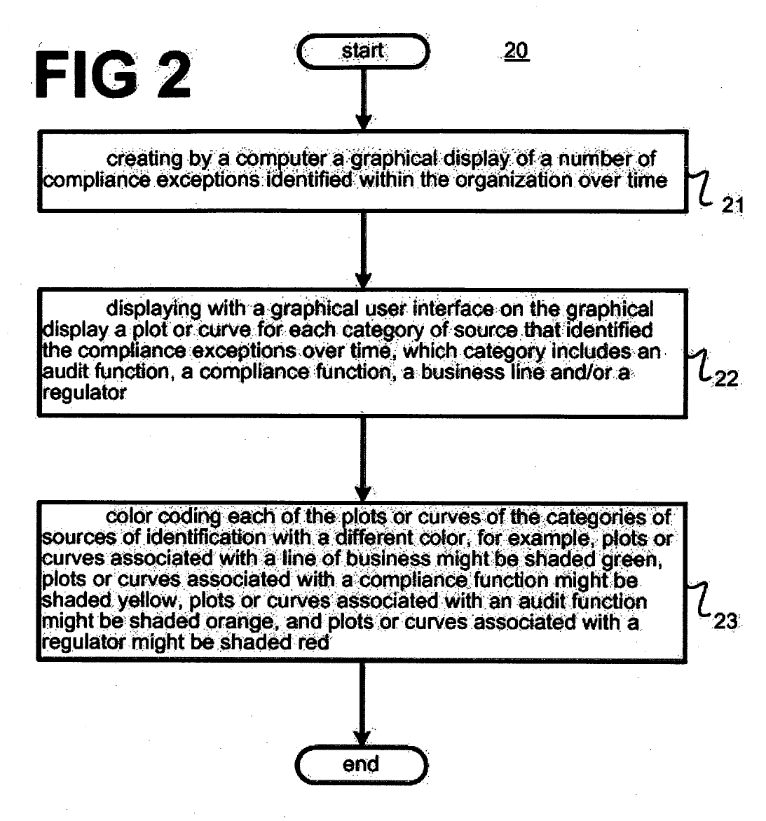

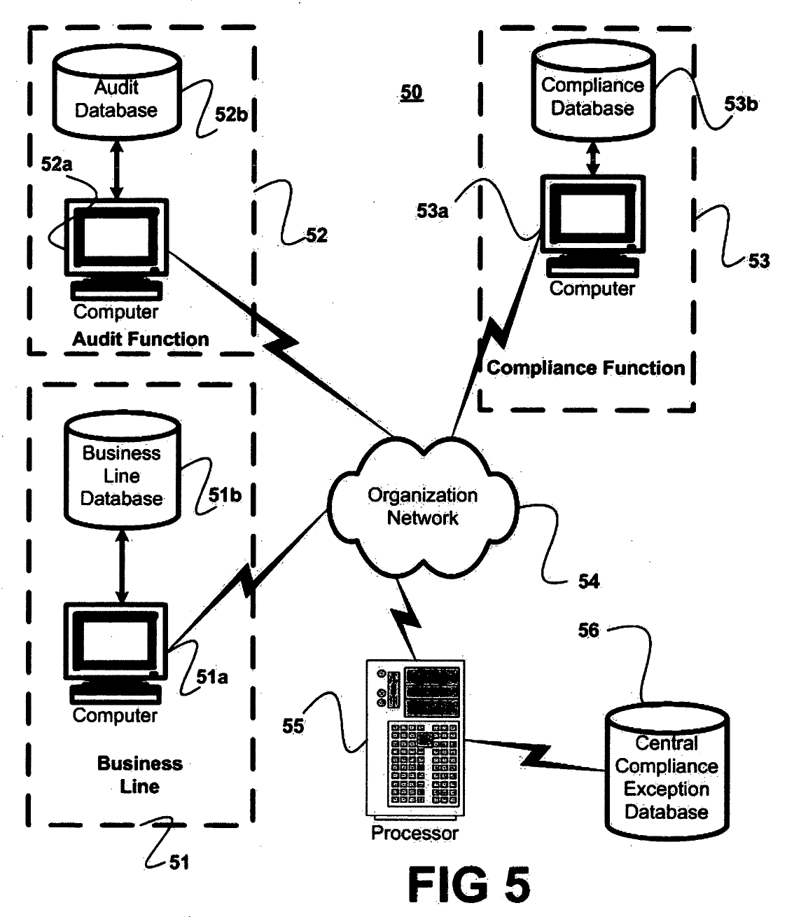

Turning to FIG. 2, shown therein is an exemplary embodiment 20 of a method for monitoring and analyzing an organizations' compliance risk according to another aspect of the present invention. This embodiment 20 can be implemented, for example, on an apparatus 50 as shown in FIG. 5, which includes one or more computers 51a-53a, such as personal computers or workstations, coupled via a network 54 to a company-maintained central database 56 of compliance exceptions that is accessible via a server or other processor 55. While one company-maintained database 56 is shown, this database is merely one possible implementation of a potential plurality of databases distributed throughout the organization that might contain data regarding compliance exceptions. For example, each business line 51 might maintain its own database 51b and each auditor function 52 or compliance function 53 might maintain its own database 52b, 53b, respectively, of compliance exceptions. Thus, database 56 might be comprised of multiple databases, from which data is pulled by or sent to a processor 55 to create the desired graphical displays. Thus, FIG. 5 shows both a central database 56 as well as databases controlled by various functions within the organization. Some or all of these databases 51b-53b, and 56 may contain records regarding compliance exceptions. Moreover, while only one business line 51, audit function 52 and compliance function 53 are depicted, these are merely representative as there could be multiple ones of each within a large organization.

In this embodiment 50, the computers 51a-53a can query the company-maintained database 56 via processor 55 to develop the graphical displays or implementations discussed in FIGS. 2-4, or, alternatively, the processor 55 can develop and maintain these displays and transmit them to the various computers 51a-53a as requested. Of course, these individual computers 51a-53a could query the other databases in the organization 50 to develop their own graphical displays as desired. While only three computers 51a-53a are shown, the apparatus 50 is not limited to three or even as many as three computers. Any number of computers may be coupled to the network 54 and therefore to the database 56 and processor 55. Moreover, any standard computer, network, server and database may be employed to implement the methods discussed herein, as long as the computer is capable of displaying or printing the plots shown in FIG. 1 and the database is capable of maintaining relationships between the compliance exceptions and the source that identified the compliance exceptions.

Turning back to FIG. 2, in step 21, a graphical display of a number of compliance exceptions identified within the organization over time is created by a computer, such as the processor 55 shown in FIG. 5 or one of the computers 51a-53a shown in the same figure.

In step 22, a plot or curve is displayed on the graphical display for each category of source that identified the compliance exceptions over time, which category includes an audit function, a compliance function, a business line and/or a regulator. The graphical user interface may include a display coupled to a computer, such as one of the computers 51a-53a shown in FIG. 5. These plots for each source may or may not have the same temporal relationship. For example, data for some periods may not exist from a given source for a time period for which another source has data.

In step 23, each of the plots or curves of the categories of sources of identification is color coded with a different color. For example, plots or curves associated with a line of business might be shaded green, plots or curves associated with a compliance function might be shaded yellow, plots or curves associated with an audit function might be shaded orange, and plots or curves associated with a regulator might be shaded red. This coloring may be determined by, for example, the processor 55 that creates the graphical implementation and then implemented by the graphical user interface, such as the computers 51a-53a of FIG. 5.

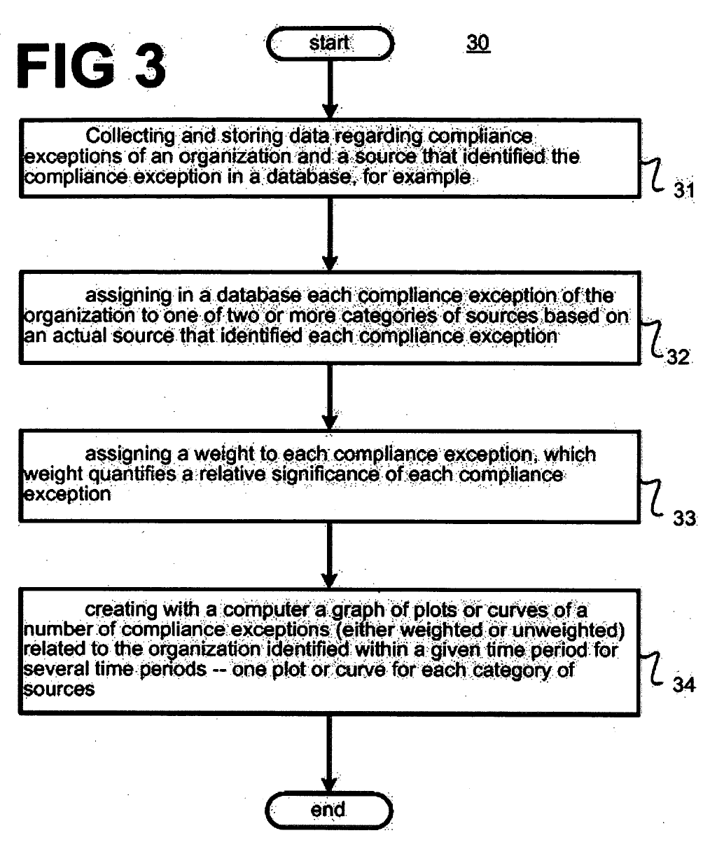

Turning to FIG. 3, shown therein is an exemplary embodiment 30 of a computer-implemented method for analyzing compliance risk in an organization. This method may be implemented by the apparatus 50 shown in FIG. 5, for example.

In step 31, data regarding compliance exceptions of an organization and a source that identified the compliance exception is collected and stored in a database, for example. As mentioned before, this data may be collected and stored in multiple databases within (or related to) the organization. The compliance exception data may be collected by users of the computers 51a-53a of FIG. 5, for example, and then input to the apparatus 30 by these users via computers 51a-53a and then stored in database 56 (or multiple databases 51b-53b) under control (or accessible by) of server/processor 55 or the individual computers 51a-53a, respectively, or some other servers not shown. One computer 51a represents a business line 51 user, however, a business line 15 might employ multiple computers to enter compliance exception data. Another computer 52a represents an audit function 52 user, however, an audit function 52 might employ multiple computers to enter compliance exception data. And, another computer 53a represents a compliance function 53 user, however, a compliance function 53 might employ multiple computers to enter compliance exception data. The regulator may not have access to the apparatus 30, so this data may be input by the compliance function 53 user, for example, and noted in the entry so its source is properly stored in database 56 or in database 53b. Of course, if desired, a separate computer (not shown) could be used to enter regulator identified compliance exceptions. The collected data may include a nature of the compliance exception, a quantity of loss associated with the compliance exception, the actual source that identified the compliance exception, the relative significance of the compliance exception, the category of compliance exception to which the actual source belongs and other pertinent information. All this information is recorded in one ore more relational databases 51b-53b, 56, for example, such as shown in FIG. 5, to enable queries regarding these compliance exceptions to be made of the database to generate the type of graphical displays shown in FIG. 1.

In step 32, in a database each compliance exception of the organization is assigned to one of two or more categories of sources based on an actual source that identified each compliance exception. This assignment can be conducted by the user creating the initial compliance exception record or automatically by an administrator of the compliance exception database who determines the exact categories to be used. This could be modified depending on the desired output.

In step 33, a weight is assigned to each compliance exception, which weight quantifies a relative significance of each compliance exception. As with the assignment of the category of source to a given compliance exception, this assignment of relative significance can be conducted by the user creating the initial compliance exception record or automatically by an administrator of the compliance exception database who determines the method by which the weighting if performed. This could also be modified depending on the desired output.

Finally, in step 34, a graph of plots or curves of a number of compliance exceptions (either weighted or unweighted) related to the organization identified within a given time period for several time periods is created by a processor or computer. One plot or curve is created for each source category. The ultimate display may resemble that shown in FIG. 1, of course, the relationship between the plots or curves may vary depending on the nature of the underlying data. Other plots may be created as has been discussed above.

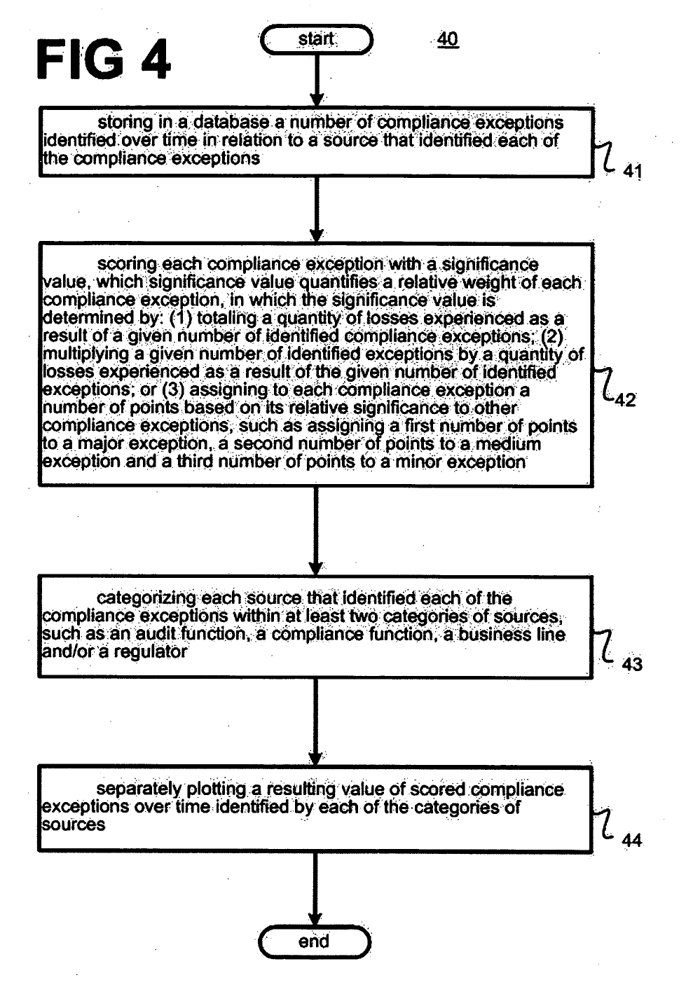

Turning to FIG. 4, shown therein is an exemplary embodiment 40 of a computer implemented method for monitoring and analyzing compliance risk in an organization according to yet another aspect of the present invention.

In step 41, a number of compliance exceptions identified over time in relation to a source that identified each of the compliance exceptions is stored in a database. This data may be stored in the database 56 of FIG. 5, for example, or multiple databases as has been discussed above.

In step 42, each compliance exception is scored with a significance value. The significance value quantifies a relative weight of each compliance exception. The significance value may be determined by several techniques. Three possible techniques are: (1) totaling a quantity of losses experienced as a result of a given number of identified compliance exceptions; (2) multiplying a given number of identified exceptions by a quantity of losses experienced as a result of the given number of identified exceptions; or (3) assigning to each compliance exception a number of points based on its relative significance to other compliance exceptions, such as assigning a first number of points to a major exception, a second number of points to a medium exception and a third number of points to a minor exception.

In step 43, each source that identified each of the compliance exceptions is categories within at least two categories of sources, such as an audit function, a compliance function, a business line and/or a regulator.

In step 44, a resulting value of scored compliance exceptions is separately plotted over time. This plot identifies each of the categories of sources.

Although various embodiments are specifically illustrated and described herein, it will be appreciated that modifications and variations of the invention are covered by the above teachings and within the purview of the appended claims without departing from the spirit and intended scope of the invention. For example, while FIG. 1 depicts four specific categories of sources by which compliance risk can be evaluated, other sources may be used in the same analysis. In addition, while some of the above embodiments use specific techniques for weighting the significance of a given compliance exception, others may be used as well. Moreover, these examples should not be interpreted to limit the modifications and variations of the invention covered by the claims but are merely illustrative of some possible variations.

Moreover, all the features disclosed in this specification (including any accompanying claims, abstract and drawings) and/or all of the steps or any method or process so disclosed, may be combined in any combination, except combinations where at least some of the steps or features are mutually exclusive. Each feature disclosed in this specification (including any claims, abstract and drawings) may be replaced by alternative features serving the same equivalent or similar purpose, unless expressly stated otherwise. Thus, unless expressly stated otherwise, each feature disclosed is one example only of a generic series of equivalent or similar features.

What is claimed is:

1. A computer-implemented method for analyzing compliance risk in an organization comprising:
creating by a computer a graphical display of a number of compliance exceptions identified within the organization over time; and
displaying with a computer in the graphical display a plot over time of a number of compliance exceptions identified within the organization for each of a plurality of sources that identified the plurality of compliance exceptions.

2. The computer-implemented method according to claim 1, wherein said step of displaying further comprises:
displaying on the graphical display an audit function plot that depicts a number of compliance exceptions over time identified by an audit function within the organization.

3. The computer-implemented method according to claim 1, wherein said step of displaying further comprises:
displaying on the graphical display a business line plot that depicts a number of compliance exceptions over time identified by a business line within the organization.

4. The computer-implemented method according to claim 2, wherein said step of displaying further comprises:
displaying on the graphical display a business line plot that depicts a number of compliance exceptions over time identified by a business line within the organization.

5. The computer-implemented method according to claim 1, wherein said step of displaying further comprises:
displaying on the graphical display a compliance function plot that depicts a number of compliance exceptions over time identified by a compliance function within the organization.

6. The computer-implemented method according to claim 2, wherein said step of displaying further comprises:
displaying on the graphical display a compliance function plot that depicts a number of compliance exceptions over time identified by a compliance function within the organization.

7. The computer-implemented method according to claim 3, wherein said step of displaying further comprises:
displaying on the graphical display a compliance function plot that depicts a number of compliance exceptions over time identified by a compliance function within the organization.

8. The computer-implemented method according to claim 1, wherein said step of displaying further comprises:
displaying on the graphical display a regulator plot that depicts a number of compliance exceptions over time identified by one or more regulators that perform regulatory oversight over the organization.

9. The computer-implemented method according to claim 2, wherein said step of displaying further comprises:
displaying on the graphical display a regulator plot that depicts a number of compliance exceptions over time identified by one or more regulators that perform regulatory oversight over the organization.

10. The computer-implemented method according to claim 3, wherein said step of displaying further comprises:
displaying on the graphical display a regulator plot that depicts a number of compliance exceptions over time identified by one or more regulators that perform regulatory oversight over the organization.

11. The computer-implemented method according to claim 5, wherein said step of displaying further comprises:
displaying on the graphical display a regulator plot that depicts a number of compliance exceptions over time identified by one or more regulators that perform regulatory oversight over the organization.

12. The computer-implemented method according to claim 4, wherein said step of displaying further comprises:
displaying on the graphical display a compliance function plot that depicts a number of compliance exceptions over time identified by a compliance function within the organization.

13. The computer-implemented method according to claim 4, wherein said step of displaying further comprises:
displaying on the graphical display a regulator plot that depicts a number of compliance exceptions over time identified by one or more regulators that perform regulatory oversight over the organization.

14. The computer-implemented method according to claim 6, wherein said step of displaying further comprises:
displaying on the graphical display a regulator plot that depicts a number of compliance exceptions over time identified by one or more regulators that perform regulatory oversight over the organization.

15. The computer-implemented method according to claim 7, wherein said step of displaying further comprises:
displaying on the graphical display a regulator plot that depicts a number of compliance exceptions over time identified by one or more regulators that perform regulatory oversight over the organization.

16. The computer-implemented method according to claim 12, wherein said step of displaying further comprises:
displaying on the graphical display a regulator plot that depicts a number of compliance exceptions over time identified by one or more regulators that perform regulatory oversight over the organization.

17. A computer-implemented method for analyzing compliance risk in an organization comprising:
storing in a database data regarding each compliance exception of the organization, wherein said data includes at least a time when the compliance exception was identified, and a source that identified the compliance exception;
assigning in a database each compliance exception of the organization to one of two or more predetermined categories of sources based on an actual source that identified said each compliance exception; and
creating with a computer a graph of a plurality of plots of a number of compliance exceptions related to the organization identified within a given time period for a plurality of time periods, one plot for each of said two or more predetermined categories of sources.

18. The method according to claim 17, further comprising:
assigning a weight to each compliance exception, wherein said weight quantifies a relative significance of said each compliance exception, and said step of creating further comprises creating with a computer a graph of a plurality of plots of weighted compliance exceptions related to the organization identified within a given time period for a plurality of time periods, one plot for each of said two or more predetermined categories of sources.

19. An apparatus for monitoring and analyzing compliance risk in an organization comprising:
a database to store a number of compliance exceptions identified over time in relation to a source that identified each of the compliance exceptions;
a processor to score each compliance exception with a significance value, wherein said significance value quantifies a relative weight of said each compliance exception;
said processor to categorize each said source that identified each of the compliance exceptions within at least two predetermined categories of sources; and
a graphical user interface to separately plot a resulting value of scored compliance exceptions over time identified by each of said at least two categories of sources.

20. The apparatus according to claim 19, wherein said processor determines said significance value by totaling a quantity of losses experienced as a result of a given number of identified compliance exceptions.

21. The apparatus according to claim 20, wherein said processor determines said significance value by multiplying a given number of identified exceptions by a quantity of losses experienced as a result of said given number of identified exceptions.

22. The apparatus according to claim 20, wherein said processor determines the significance value by assigning to each compliance exception a number of points based on its relative significance to other compliance exceptions, and by assigning a first predetermined number of points to a major exception, a second predetermined number of points is assigned to a medium exception and a third predetermined number of points to a minor exception.
